(19) United States
(12) Patent Application Publication
(10) Pub. No.: US 2003/0228497 A1
(43) Pub. Date: Dec. 11, 2003

(54) Protective overcoat materials

(76) Inventors: Mei-Ling Wu, Cranberry Township, PA (US); James K. Howard, Pittsburgh, PA (US); Paul M. Jones, Pittsburgh, PA (US)

Correspondence Address: Benjamin T. Queen, II, Pietragallo, Bosick & Gordon, One Oxford Centre, 38th Floor, 301 Grant Street, Pittsburgh, PA, 15219, US

(21) Appl. No.: 10/305,518

(22) Filed: Nov. 27, 2002

Related U.S. Application Data
(60) Provisional application No. 60/386,602, filed on Jun. 5, 2002.

(51) Int. Cl. B32B 3/00

(52) U.S. Cl. 428/694 TP; 428/694 R

(57) ABSTRACT

An overcoating for electronic devices, such as magnetic recording devices, includes an intermediate layer formed adjacent to or on the device and a protective layer formed adjacent to or on the intermediate layer. The intermediate layer and protective layer may have a combined thickness in the range of about 6 angstroms to about 35 angstroms. The intermediate layer may be formed of a material such as silicon, aluminum or boron containing borides, carbides, nitrides, oxides or oxynitrides. The protective layer may be formed of a metal oxide material.

### CROSS REFERENCE TO RELATED APPLICATION

This application claims the benefit of United States Provisional Application No. 60/386,602 filed Jun. 5, 2002.

### FIELD OF THE INVENTION

The invention relates to protective overcoat materials, and more particularly, to a dual layer protective overcoat that may be used on magnetic recording devices.

### BACKGROUND OF THE INVENTION

It is generally known to employ a layer of protective overcoat material on various electronic devices or components to, for example, prevent corrosion and increase wear protection. For example, such protective overcoats are used on magnetic recording devices, and particularly on the magnetic recording heads and/or magnetic recording media thereof.

Most magnetic recording devices operate using a contact start/stop (CSS) method where the recording head begins to slide against the surface of the recording medium as the recording medium begins to rotate. Upon reaching a predetermined rotational speed, the recording head floats in air at a predetermined distance from the surface of the recording medium, i.e. the flying height, where it is maintained during reading and recording operations. Upon terminating operation, the recording head again begins to slide against the surface of the recording medium and eventually stops in contact therewith and presses against the recording medium.

There is a demand in the computer hard drive industry to develop disc drives with an increased areal storage density. To achieve the increased areal storage density, the flying height and/or the head to media spacing between the recording head and the recording medium need to be minimized. This in turn means that the thickness of the protective overcoat material used on the recording head and/or on the recording medium needs to be minimized while still being capable of protecting the head and/or medium during the repeated CSS sequence and from corrosion.

The most common overcoat material currently used on recording heads and recording media to prevent corrosion and provide increased wear protection is a diamond like carbon (DLC) overcoat material. The thickness of DLC layers currently used is about 40-50 angstroms. However, it has been determined that a layer of the DLC overcoat having a thickness of about 20 angstroms may be the limit as to how thin the DLC overcoat can be made. Specifically, a thickness of about 20 angstroms results in the DLC layer becoming either discontinuous or porous and the DLC layer developing a high pin hole density. These results are detrimental for the material to function properly as a wear and corrosion protection overcoat. Thus, it is necessary to develop thinner overcoat materials that provide sufficient corrosion and wear protection. This development is important for ultimately achieving the desired higher areal storage density in recording devices.

Accordingly, there is identified a need for improved protective overcoats that overcome limitations, disadvantages and/or shortcomings of known protective overcoats.

In addition, there is identified a need for an improved protective overcoat for use on magnetic recording devices that overcomes limitations, disadvantages, and/or shortcomings of known overcoat materials used on magnetic recording devices.

### SUMMARY OF THE INVENTION

Embodiments of the invention meet the identified needs, as well as other needs, as will be more fully understood following a review of the specification and drawings.

In accordance with an aspect of the invention, an overcoating for electronic devices includes an intermediate layer adjacent to the electronic device and a protective layer adjacent to the intermediate layer. The intermediate layer and the protective layer together have a combined thickness in the range of about 6 angstroms to about 35 angstroms. More specifically, the intermediate layer may have a thickness in the range of about 2 angstroms to about 15 angstroms and the protective layer may have a thickness in the range of about 4 angstroms to about 20 angstroms. The intermediate layer may include at least one of Si, Al or B containing borides, carbides, nitrides, oxides or oxynitrides. The protective layer may be formed of a metal oxide material, such as, for example, ZrO₂, HfO₂, BeO₂, MgO₂, Ta₂O₅ Al₂O₃, Al₂TiO₅, TiO₂ SiO₂, Y₂O₃, RuO₂, or a composite or laminated structure of any combination of metal oxide materials such as, for example, Al₂O₃/ZrO₂.

In accordance with an additional aspect of the invention, a structure comprises a magnetic recording device, an intermediate layer formed on the magnetic recording device and a protective layer formed on the intermediate layer. The magnetic recording device may be, for example, a recording head or a recording medium.

In accordance with yet another aspect of the invention, a method for overcoating a device comprises depositing on the device an intermediate layer of material having a thickness in the range of about 2 angstroms to about 15 angstroms, and depositing on the intermediate layer a protective layer of material having a thickness in the range of about 4 angstroms to about 20 angstroms.

### BRIEF DESCRIPTION OF THE DRAWINGS

FIG. 1 is a pictorial representation of a disc drive system that may utilize the invention.

FIG. 2 is a partially schematic side view of an embodiment of a recording head and recording medium in accordance with the invention.

FIG. 3 is a partially schematic side view of an additional embodiment of a recording head and recording medium constructed in accordance with the invention.

FIG. 4 is a schematic illustration of a thin film structure constructed to illustrate an aspect of the invention.

FIG. 5 is a graphical illustration of oxidation percentage versus thickness for the thin film structure shown in FIG. 4.

FIG. 6 is a schematic illustration of a thin film structure constructed in accordance with the invention.

FIG. 7 is a graphical illustration of the high resolution Co2p3 spectra for the thin film structure shown in FIG. 6.

### DETAILED DESCRIPTION OF THE INVENTION

The invention relates to protective overcoat materials, and more particularly, to a dual layer protective overcoat that may be used, for example, on magnetic recording devices. While the invention is particularly suitable for use with magnetic recording devices, such as the magnetic recording head, slider and magnetic recording medium thereof, it will be appreciated that the invention may also be used with other type storage systems such as, for example, magneto-optical or optical storage systems. In addition, it will be appreciated that the protective overcoat of the invention may be utilized on various other electronic devices or components such as, for example, micro-electromechanical systems (MEMS), optical devices, cutting tools, automobile components or aerospace components.

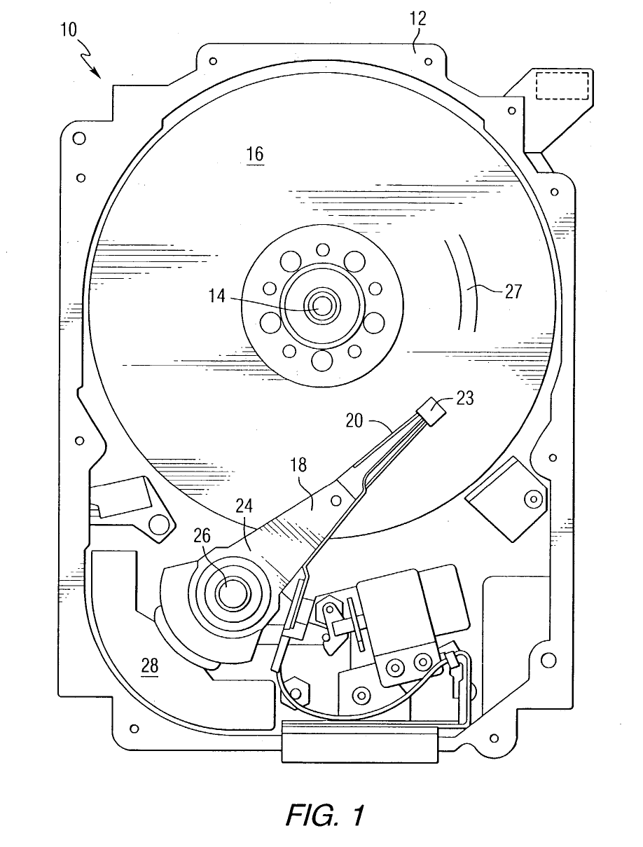

FIG. 1 is a pictorial representation of a disc drive 10 that can utilize a magnetic recording head, which may be a longitudinal, perpendicular or other type recording head, constructed in accordance with this invention. The disc drive 10 includes a housing 12 (with the upper portion removed and the lower portion visible in this view) sized and configured to contain the various components of the disc drive. The disc drive 10 includes a spindle motor 14 for rotating at least one storage medium 16. At least one arm 18 is contained within the housing 12, with each arm 18 having a first end 20 with a slider 23, and a second end 24 pivotally mounted on a shaft by a bearing 26. An actuator motor 28 is located at the arm's second end 24 for pivoting the arm 18 to position the slider 23 over a desired sector or track 27 of the disc 16. The actuator motor 28 is regulated by a controller, which is not shown in this view and is well known in the art.

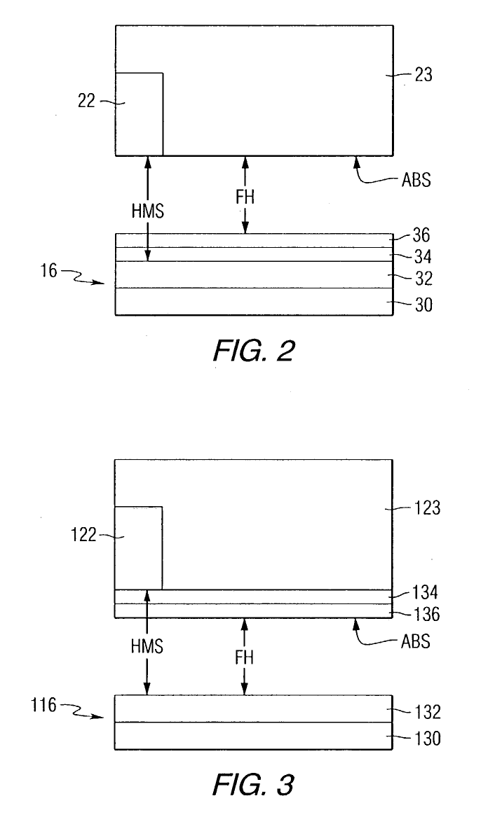

Referring to FIG. 2, there is illustrated an embodiment of a recording head 22 mounted on the slider 23. There is also illustrated a recording medium 16 positioned adjacent to or under the recording head 22 and the slider 23, as is generally known in the art. It will be appreciated that the recording medium 16 may be constructed as either a longitudinal recording medium or a perpendicular recording medium or other type recording medium as may be desired. It will be further appreciated that the recording head 22 may be constructed as either a longitudinal recording head or a perpendicular recording head or other type recording head as may be desired.

Still referring to FIG. 2, the recording medium 16 may include a substrate 30, which may be made of any suitable material such as aluminum, ceramic glass or amorphous glass. A recording layer 32 is deposited on the substrate 30. Suitable magnetic materials for the recording layer 32 may include at least one material selected from, for example, FePt or CoCrPt alloys having a relatively high anisotropy at ambient temperature.

In accordance with this embodiment of the invention, the recording medium 16 includes an intermediate layer 34 deposited on the recording layer 32. In addition, a protective layer 36 is deposited on the intermediate layer 34. The intermediate layer 34 and the protective layer 36 combine to effectively provide a protective overcoating for the recording medium 16, and particularly for the recording layer 32 thereof. For example, layers 34 and 36 combine to provide wear protection for the recording medium 16 from contact with the recording head 22 and/or the slider 23.

The protective layer 36 is separated from the air bearing surface (ABS) of the recording head 22 and the slider 23 by a distance generally referred to as the flying height (FH). The recording layer 32 is positioned from the ABS of the recording head 22 and the slider 23 by a distance generally referred to as the head-to-media spacing (HMS). The intermediate layer 34 and the protective layer 36 are deposited in very thin layers so as to allow for the flying height FH and/or the head-to-media spacing HMS dimensions to be as small as possible which is advantageous when developing recording heads and media with an increased areal storage density.

The intermediate layer 34 may have a thickness in the range of about 2 angstroms to about 15 angstroms. The protective layer 36 may have a thickness in the range of about 4 angstroms to about 20 angstroms. Thus, the combined thickness of the intermediate layer 34 and the protective layer 36 may be in the range of about 6 angstroms to about 35 angstroms.

The intermediate layer 34 may include at least one material selected from the group consisting of Si, Al and B. The intermediate layer 34 may also include at least one of a boride, a nitride, a carbide, an oxynitride or an oxide. Thus, the intermediate layer 34 may be formed of covalent hard materials, which can be used as thin intermediate adhesion layers between the material used to form the recording layer 32 and the material used to form the protective layer 36. Suitable covalent hard materials possess higher bulk modulus and mechanical hardness than most metal films, and have good wetting properties with the metal films. Therefore, these materials can enhance the mechanical properties and adhesion when used in combination with the protective layer 36 to form the protective overcoating for the recording layer 32.

The protective layer 36 may be formed of a metal oxide material. For example, the protective layer 36 may be formed of a material selected from the group consisting of ZrO₂, Hfo₂, BeO₂, MgO₂, Ta₂O₅, A12O3, Al₂TiO₅, TiO₂ SiO₂, Y₂O₃, RuO₂, or a composite or laminated structure of any combination of metal oxide materials such as, for example, Al₂O₃/ZrO₂. The metal oxide materials used to form the protective layer 36 should possess high electrical resistivity and high bulk modulus and high hardness properties.

Referring to FIG. 3, there is illustrated an additional embodiment of the invention including a recording medium 116 positioned adjacent to or under a recording head 122 and slider 123. The recording medium 116 includes a substrate 130 and a recording layer 132 formed on the substrate 130. In this embodiment, the overcoating, which includes an intermediate layer 134 and a protective layer 136, is formed on the recording head 122 and/or the slider 123. The thicknesses and the materials for forming the intermediate layer 134 and the protective layer 136 is essentially the same as described herein for the embodiment illustrated in FIG. 2 where the overcoating is formed on the recording medium 16. The intermediate layer 134 and protective layer 136 also serve a similar function in regards to the recording head 122 and/or slider 123 as does the intermediate layer 34 and protective layer 36 in regards to the recording medium 16.

It will be appreciated that while the embodiments illustrated in FIG. 2 and FIG. 3 illustrate an overcoating applied to a recording medium and a recording head/slider, respectively, the overcoating may be applied to both the recording medium and the recording head/slider if desired. A limiting factor in applying the overcoating to both the recording medium and the recording head and/or the slider would be the thicknesses of the intermediate layers and the protective layers and the impact that such thicknesses would have on the flying height FH and/or the head-to-media spacing HMS.

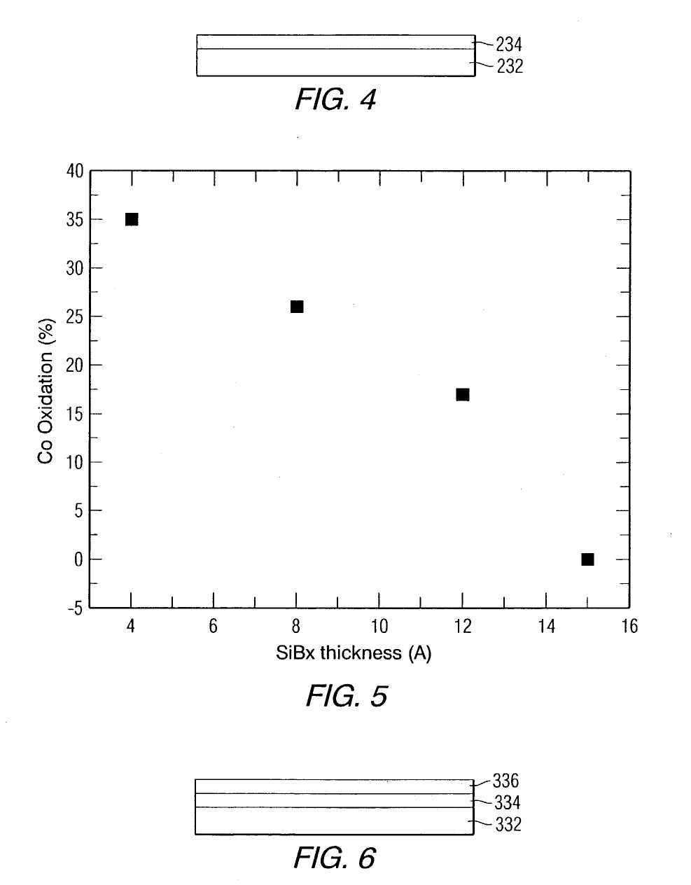

Referring to FIG. 4, there is illustrated a layer 232, formed of Co and corresponding to the recording layers 32 and 132 described herein, having an intermediate layer 234, corresponding to the intermediate layers 34 and 134 described herein, formed thereon. This thin film structure was constructed to illustrate the effectiveness of the intermediate layer in forming the overcoating of the invention. Specifically, the intermediate layer 234 was formed of a layer of SiBₓ, wherein 3≦×≦6, with thicknesses ranging from about 4 angstroms to about 15 angstroms and was deposited on the layer 232 of Co having a thickness of about 200 angstroms. The deposition was performed using DC magnetron sputtering at an Ar total pressure of 1-2 mTorr. Electron spectroscopy for chemical analysis (ESCA) was used to obtain high resolution Co2p3 peaks to evaluate the continuity of the thin films of the intermediate layer 234. The reactive DC sputtering of the metal oxide materials can be modified to RF sputtering from oxide targets to prevent in-situ oxygen plasma oxidation of the recording layer 32 and to simplify the deposition control process.

FIG. 5 illustrates the percentage of oxidized Co for the layer 232 as a function of the thickness of the intermediate layer 234. The results suggest that an intermediate layer 234 of SiBₓ as thin as 15 angstroms is sufficient to prevent the Co layer 232 from reacting with oxygen at ambient temperature. These results further suggest a good wetting property between the Co layer 232 and the intermediate layer 234. Therefore, a thin layer of SiBₓ can be used as an effective intermediate layer 234 between media materials and oxide overcoat materials, such as used to form the protective layer.

To further illustrate the invention, reference is made to FIG. 6. Specifically, an intermediate layer 334 is formed on a layer 332 of Co and a protective layer 336 is formed on the intermediate layer 334. The layer 332 had a thickness of about 200 angstroms, the intermediate layer 334 was formed of SiBₓ, wherein 3≦×≦6, with a thickness of about 8 angstroms and the protective layer 336 was formed of ZrO₂ with a thickness of about 4 angstroms. These layers were deposited using DC magnetron sputtering at a total pressure of 1-2 m Torr (comprising Ar of 70% and O₂ of 30% in total flow rate) on Si/SiO₂ substrates (not shown). An advantage of the invention is that use of the intermediate layer, such as layer 34, 134 or 234, can prevent or minimize in-situ oxidation due to the use of an oxygen plasma. Specifically, reactive sputtering of metal oxides, such as used to form the protective layer 36, 136 or 236, may involve oxygen plasma and due to the high reactivity of oxygen plasma in the system, the control of oxygen partial pressure becomes difficult.

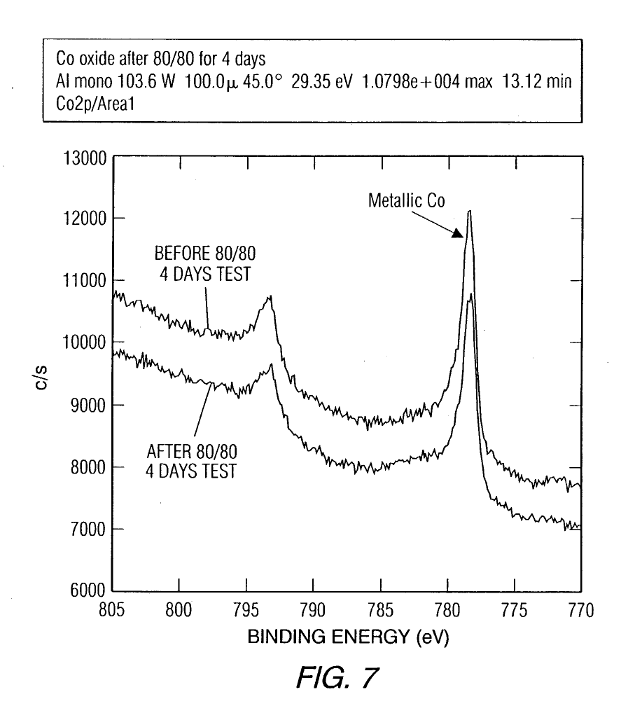

ESCA was used to obtain high resolution Co2p3 peaks to evaluate the continuity of the dual layer overcoating, i.e., the intermediate layer 334 and the protective layer 336, before and after high temperature/high humidity (80° C./80% for four days) exposures. The high resolution Co2p3 spectra results are illustrated in FIG. 7. Specifically, it was determined that Co remains in metallic form before and after the temperature and humidity tests, therefore demonstrating that the intermediate layer 334 and protective layer 336 with a combined thickness of about 12 angstroms effectively prevents the layer of Co from being oxidized at approximately ambient temperature and aggressive environments. Sputtered carbon overcoats would normally require much thicker layers to provide such oxidation protection for a pure Co underlayer. Accordingly, these results clearly show that the present invention can provide superior corrosion and wear protection for media and head materials.

Whereas particular embodiments have been described herein for the purpose of illustrating the invention and not for the purpose of limiting the same, it will be appreciated by those of ordinary skill in the art that numerous variations of the details, materials, and arrangement of parts may be made within the principle and scope of the invention without departing from the invention as described in the appended claims.

What is claimed is:

1. An overcoating for electronic devices, comprising:
an intermediate layer adjacent to the electronic device; and
a protective layer adjacent to said intermediate layer, said intermediate layer and said protective layer having a combined thickness in the range of about 6 angstroms to about 35 angstroms.

2. The overcoating of claim 1, wherein said intermediate layer has a thickness in the range of about 2 angstroms to about 15 angstroms.

3. The overcoating of claim 1, wherein said protective layer has a thickness in the range of about 4 angstroms to about 20 angstroms.

4. The overcoating of claim 1, wherein said intermediate layer includes at least one material selected from the group consisting of Si, Al, and B.

5. The overcoating of claim 4, wherein said intermediate layer further includes at least one of a boride, a nitride, a carbide, an oxynitride, or an oxide.

6. The overcoating of claim 1, wherein said protective layer is formed of a material selected from the group consisting of ZrO₂, HfO₂, BeO₂, MgO₂, Ta₂O₅, Al₂O₃, Al₂TiO₅, TiO₂, SiO₂, Y₂O₃, and RuO₂.

7. The overcoating of claim 1, wherein said protective layer is formed of a metal oxide material.

8. A structure, comprising:
a magnetic recording device;
an intermediate layer formed on said magnetic recording device, said intermediate layer having a thickness in the range of about 2 angstroms to about 15 angstroms; and
a protective layer formed on said intermediate layer, said protective layer having a thickness in the range of about 4 angstroms to about 20 angstroms.

9. The structure of claim 8, wherein said magnetic recording device is a recording head.

10. The structure of claim 8, wherein said magnetic recording device is a recording medium.

11. The structure of claim 8, wherein said intermediate layer includes at least one material selected from the group consisting of Si, Al, and B.

12. The structure of claim 11, wherein said intermediate layer further includes at least one of a boride, a nitride, a carbide, an oxynitride, or an oxide.

13. The structure of claim 8, wherein said protective layer is formed of a material selected from the group consisting of ZrO₂, HfO₂, BeO₂, MgO₂, Ta₂O₅, Al₂O₃, Al₂TiO₅, TiO₂, SiO₂, Y₂O₃, and RuO₂.

14. The structure of claim 8, wherein said protective layer is formed of a metal oxide material.

15. A method for overcoating a device, comprising:
depositing on the device an intermediate layer of material having a thickness in the range of about 2 angstroms to about 15 angstroms; and
depositing on the intermediate layer a protective layer of material having a thickness in the range of about 4 angstroms to about 20 angstroms.

16. The method of claim 15, further including forming said intermediate layer of at least one material selected from the group consisting of Si, Al, and B.

17. The method of claim 16, further including forming said intermediate layer of at least one of a boride, a nitride, a carbide, an oxynitride, or an oxide.

18. The method of claim 15, further including forming said protective layer of a material selected from the group consisting of ZrO₂, HfO₂, BeO₂, MgO₂, Ta₂O₅, Al₂O₃, Al₂TiO₅, TiO₂, SiO_{2,}, Y₂O₃, and RuO₂.

19. The method of claim 15, further including forming said protective layer of a metal oxide material.

20. A magnetic recording head formed according to the method of claim 15.

21. A magnetic recording medium formed according to the method of claim 15.
